(19) United States
(12) Patent Application Publication
(10) Pub. No.: US 2018/0012090 A1
(43) Pub. Date: Jan. 11, 2018

(54) VISUAL LEARNING SYSTEM AND METHOD FOR DETERMINING A DRIVER'S STATE

(71) Applicant: JUNGO CONNECTIVITY LTD., Netanya (IL)

(72) Inventor: OPHIR HERBST, HERZLIYA (IL)

(21) Appl. No.: 15/203,835

(22) Filed: Jul. 7, 2016

(51) Int. Cl. G06K 9/00; G06K 9/62; G06K 9/20; G06K 9/78

(52) U.S. Cl. CPC G06K 9/00845; G06K 9/78; G06K 9/6256; G06K 9/6212; G06K 9/00335; G06K 9/209; G06K 9/00597; G06K 9/00362; G06K 9/6202

(57) ABSTRACT

A method and system for monitoring a driver's state include obtaining a baseline biometric parameter value of a driver from a first set of images, obtaining a current biometric parameter value of the driver from a second set of images, comparing the current value with the baseline value and determining the driver's state based on the comparison.

### FIELD

The present invention relates to the field of driver monitoring.

### BACKGROUND

Traffic accidents involving vehicles are one of the leading causes of injury and death in many developed countries. Traffic accidents may often be attributed to human error. Therefore, monitoring human drivers of vehicles is an important component of accident analysis and prevention.

Safety systems meant to sound an alarm when unsafe driving is detected, have been introduced into vehicles by several car companies. Some safety systems use steering input from the electric power steering system of the car to detect steering patterns that are unsafe driving patterns.

Other safety systems use a camera to monitor a driver's eyes or another sensor to measure a different parameter such as brain activity, heart rate, skin conductance, muscle activity, etc. The measured parameter is compared to a preset value to determine the driver's state, thus providing a “one for all” but less than accurate driver monitoring solution.

### SUMMARY

Embodiments of the invention provide a method and system for personalized, thus accurate, analysis of a driver's state by means of biometrics extracted from images, using computer vision.

Embodiments of the invention provide a system and method for learning a specific driver's long term behavior in a vehicle and identifying distraction or another state of the driver by comparing short term behavior of the driver in the vehicle to his long term behavior.

In some embodiments biometric parameters (also referred to as biometrics) of the driver are combined to determine a driver's state based on more than one biometric, enabling a quick and accurate identification of a driver's state that may lead to unsafe driving.

In some embodiments determination of the driver's state may be used to control systems of the vehicle and/or auxiliary devices.

In one embodiment a method for monitoring a driver's state includes obtaining a baseline biometric parameter value of a driver from a first set of images; obtaining a current biometric parameter value of the driver from a second set of images; comparing the current value with the baseline value; and outputting a signal based on the comparison.

In some embodiments the method includes identifying a first driver in at least one image from the first set of images; identifying a second driver in at least one image from the second set of images; correlating the second driver with the first driver; and comparing the current value with the baseline value based on the correlation.

The baseline value and the current value may each include a combination of values. Additionally, the baseline value and the current value may each include a statistical property of a biometric parameter value. In some embodiments the baseline value and the current value each include a combination of values, each value comprising a different statistical property.

In one embodiment a method for determining a driver's state includes obtaining a plurality of biometric parameter values of a driver from images of the driver in a vehicle; determining the driver's state based on a combination of the plurality of values; and outputting a signal based on the driver's state.

Determining the driver's state may be based on a comparison of the combination of values of the driver to a combination of previously obtained values of the driver (obtained from previous images of the driver in the vehicle).

In some embodiments the method may include assigning a different weight to each of the plurality of values and combining the weighted parameters.

Embodiments of the invention also relate to a system which includes a processing unit to track at least part of a driver in a first set of images to extract biometric parameter values of the driver based on the tracking, to store the values in a biometric database associated with the driver and to compare biometric parameter values of the driver extracted based on tracking of the part of the driver in a second set of images to the values stored in the biometric database.

The system may also include an image sensor in communication with the processing unit, to obtain images of at least part of the driver.

In some embodiments the processing unit is to identify the driver from at least one image from the first set of images and to communicate with the biometric database based on the driver identification.

The processing unit may be configured to control an auxiliary device based on the comparison of the biometric parameter values of the driver.

Some embodiments include a method for controlling a device in a vehicle. In one embodiment the method includes comparing current biometric parameters of a driver in the vehicle with normal biometric parameters of the driver in the vehicle and adjusting a threshold of an auxiliary device in the vehicle based on the comparison. In another embodiment the method includes determining a driver's state from images of the driver and adjusting a threshold of an auxiliary device in the vehicle based on the driver's state.

### BRIEF DESCRIPTION OF THE DRAWINGS

The invention will now be described in relation to certain examples and embodiments with reference to the following illustrative drawing figures so that it may be more fully understood. In the drawings:

FIG. 1 is a schematic illustration of a system operable according to embodiments of the invention;

FIGS. 2A and 2B are schematic illustrations of methods for personalized monitoring of a driver's state, according to embodiments of the invention;

FIGS. 3A and 3B are schematic illustrations of methods for personalized monitoring of a driver's state, according to additional embodiments of the invention;

FIG. 4 is a schematic illustration of a method for monitoring a driver's state, based on a combination of biometrics, according to embodiments of the invention; and

FIGS. 5A and 5B are schematic illustrations of methods for controlling a device based on a driver's state, according to embodiments of the invention.

### DETAILED DESCRIPTION

Embodiments of the invention provide systems and methods for monitoring a driver's state using biometric parameters, typically extracted from images of the driver.

The terms “driver” and “driving” used in this description refer to an operator or operating of a vehicle and embodiments of the invention relate to operation of any vehicle (e.g., car, train, boat, airplane, etc.).

In one embodiment a driver's state refers to the level of distraction of the driver. Distraction may be caused by external events such as noise or occurrences in or outside the vehicle, and/or by the physiological or psychological condition of the driver, such as drowsiness, anxiety, sobriety, inattentive blindness, readiness to take control of the vehicle, etc. Thus, a driver's state may be effected by the physiological and/or psychological condition of the driver.

Biometric parameters extracted from images of the driver, typically by using computer vision techniques, include parameters indicative of the driver's state, such as, eye pupil direction (gaze), pupil diameter, head rotation, blink frequency, mouth area size/shape, eye size, percentage of eyelid closed (PERCLOS), location of head and/or pose of driver, heart rate, temperature and others.

In one embodiment a driver is identified and one or more biometric parameters of the identified driver are extracted, typically over a long period of time (e.g., a few hours, days or even weeks). These long term biometrics and/or their values and/or statistical properties of these values are stored, for example, in a database (DB) which is specific to the identified driver. These long term biometric values (which may include statistical properties such as standard deviation, average value, average length, etc.) represent the baseline or normal value of the driver's biometric parameters. Values (which may include statistical properties) generated from biometric parameters extracted during a short period of time (e.g., a few minutes or seconds) are typically compared to the long term biometric values and this comparison may be used to understand the driver's state and/or to update the long term biometric values.

The baseline value (obtained from long term biometrics) can be updated by adding short term values (obtained from short term biometric parameters) of the driver extracted during future measurements, when the same driver is identified. In each new measurement the value(s) and/or statistical properties of the short term parameter(s) is compared to the baseline. If the value(s) and/or statistical properties of the newly extracted short term biometric(s) is within a predetermined range from the baseline value then it may be used to update the baseline value. If the value of the new short term biometric(s) deviates from the baseline (e.g., the new value is not in the predetermined range, or its standard deviation is outside the long term standard deviation) then the short term value is not used to update the baseline and an alarm or other a signal may be generated.

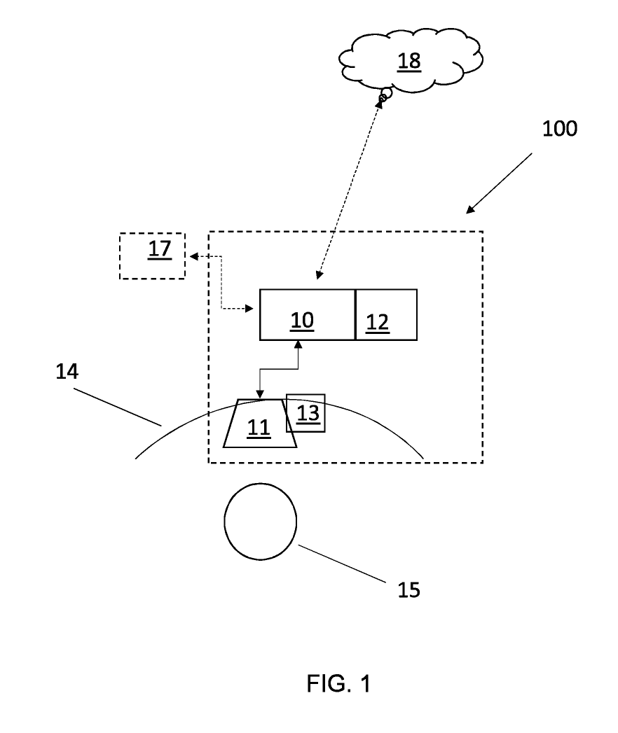

An example of a system operable according to embodiments of the invention is schematically illustrated in FIG. 1.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” “detecting”, “identifying”, “extracting” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In one embodiment a system 100 includes an image sensor 11 which may be part of a camera located in a vehicle 14 and configured to obtain an image of the driver, typically, an image that includes at least part of the driver, such as the driver's head 15. For example, one or more cameras may be positioned on a car's windshield, on the sun visor of the car, on the front mirror of the car, on a front window of an aircraft or ship, etc. The camera(s) may have a wide enough field of view (FOV) so that at least the driver's head 15 is included in images obtained from the image sensor 11.

The image sensor 11 typically includes a CCD or CMOS or other appropriate chip. The camera may be a 2D or 3D camera. In one embodiment several image sensors may be used to obtain a 3D or stereoscopic image of at least the driver's head 15.

In one embodiment image sensor 11 obtains images at a high frame rate (e.g., 30 frames per second or higher) to achieve real-time imaging.

In some embodiments the system 100 includes one or more illumination source 13 such as an infra-red (IR) illumination source, to facilitate imaging (e.g., to enable obtaining images of the driver even in low lighting conditions, e.g., at night).

The image sensor 11 is typically associated with a processing unit 10 and a memory 12.

Processing unit 10 may be used for extracting biometric parameters and/or values (which may include statistical properties) of a driver from images obtained by image sensor 11. In some embodiments processing unit 10 (or another processor) is used to identify the driver and to associate the identified driver to specific biometric parameter values. According to one embodiment, detecting biometrics and/or identifying the driver are based on applying machine learning techniques on-line. Thus, both biometrics and driver identification may be updated on the fly.

Processing unit 10 may track a driver's head or face in a set of images obtained from image sensor 11 and extract biometric parameter values of the driver based on the tracking. In one embodiment biometric parameter values of a specific driver obtained from a first set of images are used to represent the baseline or normal state of the driver and may thus be used as a reference frame for biometric parameter values of that same driver obtained from a second, later, set of images.

The first set of images typically includes long term images, e.g., images obtained over a few hours or even a few days or weeks. The second set of images typically includes short term images, e.g., images obtained over a short period, e.g., a few minutes or a few seconds. Thus, the first set of images typically includes more images than the second set of images. The first set of images may typically be larger than the second set of images.

Sets of images typically include consecutive images (e.g., immediately successive frames or selected succeeding frames, e.g., every 5^{th} frame, etc.).

Processing unit 10 typically runs computer vision algorithms and processes to determine biometrics from images obtained from image sensor 11. For example, face detection and/or eye detection algorithms (including machine learning processes) may be used to detect a driver's face and/or features of the face (such as eyes) in the images. Tracking of the head or face, e.g., to detect head and/or eye movement, may be done by applying optical flow methods, histogram of gradients, deep neural networks or other appropriate detection and tracking methods. Parameters such as direction of gaze or posture or position of a driver's head may be determined by applying appropriate algorithms (and/or combination of algorithms) on image data obtained from the images, such as motion detection algorithms, color detection algorithms, detection of landmarks, 3D alignment, gradient detection, support vector machine, color channel separation and calculations, frequency domain algorithms and shape detection algorithms. In one embodiment, once a parameter is detected, time series analysis is performed by processing unit 10 or by another processor, to extract statistical properties of the determined values of the parameter. Statistical properties may include, for example, average values, standard deviation, average lengths, or other statistical properties.

Thus in one embodiment comparing baseline values to current values includes comparing the statistical properties of the baseline biometric parameter value and the statistical properties of the current biometric parameter value.

The processing unit 10 may output data or signals which may be used by processing unit 10 or by another processor to determine a value of the biometrics of the driver, to provide information and/or for controlling devices, such as an auxiliary device 17 of a vehicle.

An auxiliary device 17 is typically in communication with vehicle control systems (such as a car's computer) and may include, for example, an alarm device or an advanced driver assistance system (ADAS), e.g., cruise control, collision avoiding/warning systems, etc.

In some embodiments processing unit 10 or another associated processor runs computer vision algorithms and processes to identify a driver in at least one image. In other embodiments a driver may be identified using other and/or additional techniques. For example, a driver may be required to identify himself by registering, by fingerprints or other known identifying methods. Once a driver is identified in connection with a set of images (for example, the driver is identified in at least one image from the set of images or the driver is identified directly prior to the time of obtaining the set of images), the biometrics extracted from this set of images may be associated with the specific identified diver. Thus, a driver specific database (or other storage structure) may be used to store driver specific biometrics. Databases and/or other storage structures may also be used to store driver identities, such that in cases of multiple drivers using a single vehicle, a current driver may be compared with the driver identity database to determine the current driver identity.

Some or parts of data e.g., databases of biometrics and/or driver identities, may be stored locally on appropriate media in system 100. In some embodiments, data is stored on cloud storage 18. Additionally, processes to extract biometric parameter values and/or to determine driver identities and/or to compare biometric parameter values and/or identities, and/or other processes according to embodiments of the invention, may occur in cloud storage 18. Updates to system 100 (such as adjusted values and standard deviation values and/or adjusted rules for combining biometrics) may be sent from cloud storage 18.

Communication between components of the system 100 and/or external components (such as auxiliary device 17) and storage (e.g., cloud storage 18) may be through wired or wireless connection. For example, the system 100 may include an internet connection.

Processing unit 10 may include, for example, one or more processors and may be a central processing unit (CPU), a digital signal processor (DSP), a Graphical Processing Unit (GPU), a microprocessor, a controller, a chip, a microchip, an integrated circuit (IC), or any other suitable multi-purpose or specific processor or controller.

In some embodiments processing unit 10 is a dedicated unit. In other embodiments processing unit 10 may be part of an already existing vehicle processor, e.g., the processing unit 10 may be one core of a multi-core CPU already existing in the vehicle, such as in the vehicle IVI (In-Vehicle Infotainment) system, telematics box of the vehicle or another processor associated with the vehicle.

Memory unit(s) 12 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

According to some embodiments images may be stored in memory 12. Processing unit 10 can apply image analysis algorithms, such as known motion detection and shape detection algorithms and/or machine learning processes in combination with methods according to embodiments of the invention to analyze images, e.g., to obtain biometrics based on tracking of a driver's head and/or face in a set of images and to extract values (which may include statistical properties) from the obtained biometrics.

In one embodiment, a method for monitoring a driver's state includes obtaining baseline (long term) biometric parameters of a driver, obtaining current (short term) biometric parameters of the driver and comparing the current parameters with the baseline parameters to determine the driver's state. In one embodiment a signal is generated based on the comparison. The signal may be output (e.g., causes a display to the driver) or may be used to control processes or devices (e.g., to control an alarm and/or ADAS).

Typically, current values (which may include statistical properties) obtained from current biometric parameters are compared with baseline values (which may include statistical properties) obtained from baseline biometric parameters.

In one embodiment the baseline biometric parameters are obtained from a first set of images and the current biometric parameters are obtained from a second, later, set of images.

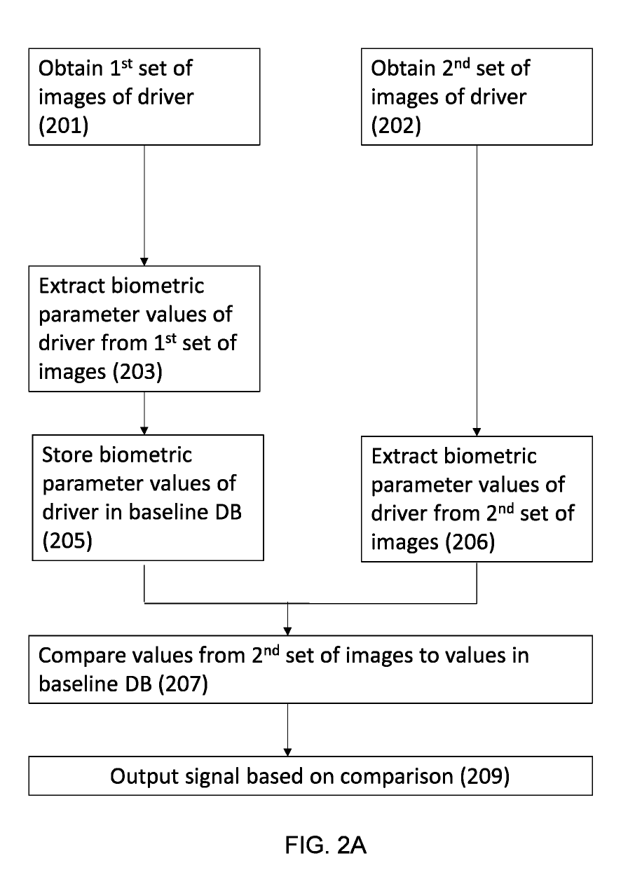

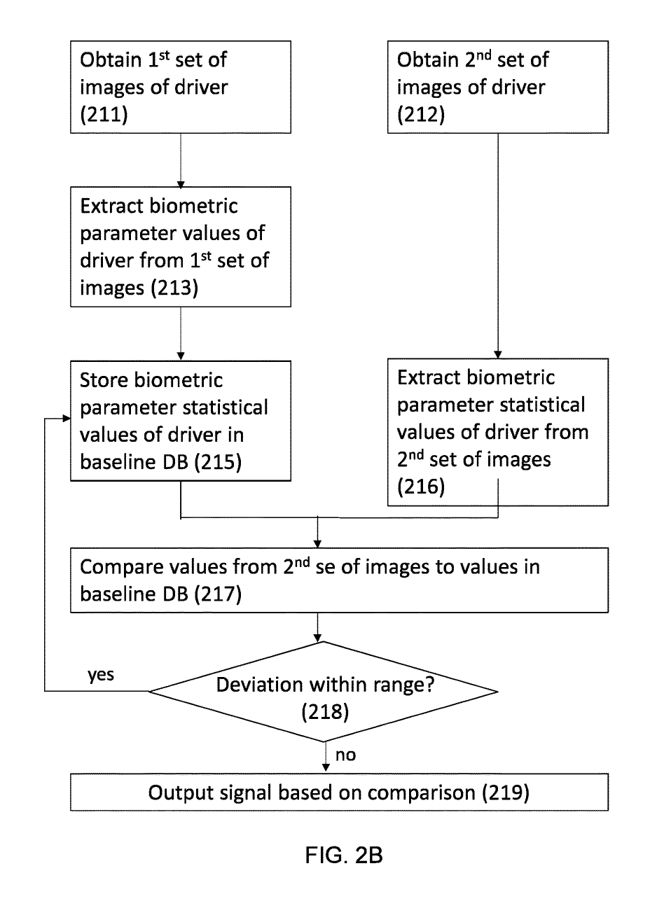

In an example of this embodiment, which is schematically illustrated in FIG. 2A, the method includes obtaining a first set of images of a driver (201) and extracting biometric parameter values of the driver from the first set of images (203). The biometric parameter values of the driver extracted from the first set of images are stored in a baseline database (baseline DB) (205) or another appropriate storage structure.

At a later time a second set of images of the driver is obtained (202) and biometric parameter values of the driver are extracted from the second set of images (206). The later extracted biometric parameter values are compared to the biometric parameter values in the baseline DB (207) and a signal is output based on the comparison (209).

The values stored in the baseline DB (or in any other appropriate storage structure) may include, for example, an average (or other statistical property) of values measured in the past seconds, minutes, days or weeks.

In some embodiments short term biometric parameter values are extracted from each frame or image in a set of images and each extracted value is compared to the baseline DB, however, an alarm or other signal is generated based on an accumulation of comparisons. Thus, for example, if imager 11 obtains 30 frames per second and each of the frames is analyzed (biometric values extracted from each frame compared to baseline values) by processor 10, in 2 seconds 60 comparisons are accumulated. Processor 10 then determines the amount (e.g., percent) of frames in which deviation has been detected and generates a signal based on the accumulated data. For example, an alarm signal is generated if more than 80% of the 60 frames show a deviation from the baseline values.

In one embodiment, which is schematically illustrated in FIG. 2B, the method includes changing (e.g., adjusting) the baseline biometric parameter value(s) of the driver based on the current biometric parameter value(s). In one example the method includes comparing a current value to the baseline and changing the baseline value based on the current value if the current value is within a predetermined range from the baseline value.

A first set of images of a driver is obtained (211) and biometric parameter values of the driver are extracted from the first set of images (213). The biometric parameter values of the driver extracted from the first set of images are stored in a baseline DB (215). The biometric parameter values extracted from the first set of images are typically collected over a relatively long period (e.g., weeks, days or hours vs. minutes or seconds) and are also referred to as long term values.

A second, later, set of images of the driver is obtained (212) and biometric parameter values of the driver are extracted from the second set of images (216). The later extracted biometric parameter values are typically collected over a relatively short period of time (e.g., seconds or minutes vs. hour or days or weeks) and are also referred to as short term values. The short term values are compared to the biometric parameter values in the baseline DB (217), namely the long term values. If the deviation of the short term values (e.g., average values or other statistical parameter) from the long term values is within a predetermined range (218) then the short term values are stored in the baseline DB (215) and/or are used to update the baseline value. If the short term values are not similar to the long term values (namely, the deviation is not within the predetermined range) (218) then a signal is output based on the comparison (219).

The predetermined range may be, for example, the standard deviation. In one embodiment values (e.g., an average of values) measured in the last few minutes (short term values) are compared to values (e.g., an average of values) measured in the past few days (long term values) and the deviation of the short term values from the long term values is calculated. If the deviation is above or below the range defined by the standard deviation of the long term values then unsafe driving (e.g., distracted or drowsy driver) is determined and a signal is generated.

The signal may be an alarm signal to warn the driver of his unsafe driving. Alternatively or in addition, the signal may be used to control another device. For example, if unsafe driving is determined, e.g., as described above, an alarm to alert the driver may be generated and/or a signal may be generated to control a device such as a collision warning/avoiding system associated with the vehicle.

In one example, a preset threshold of a collision avoiding system may allow the collision avoiding system to take control of other vehicle systems (e.g., breaks) under certain conditions (e.g., when an object is approaching the vehicle rapidly). The preset threshold may be changed (e.g., lowered) by the signal generated according to embodiments of the invention, so that, if, for example, it is detected that the driver is more drowsy than his baseline state, the collision avoiding system may take control of vehicle systems under less strict conditions (e.g., even when an object is approaching the vehicle less rapidly). In another example, whether to alarm lane departure depends on the level of distraction of the driver. Even autonomous vehicle decisions, e.g., what an automatic car should do in the case of emergency, can depend on the driver state (e.g., whether the driver is alert enough to take control).

In some cases, a single vehicle may be operated by different drivers at different times. In order to be able to compare short term biometric parameters of a specific driver to baseline (or long term) biometric parameters of that same driver, methods according to embodiments of the invention include a step of correlating or matching a driver identified in a second set of images with a driver identity from previously saved driver identities and based on the correlation comparing the short term parameter value of the driver identified in the second set of images with the long term parameter value of the driver identified in the first set of images.

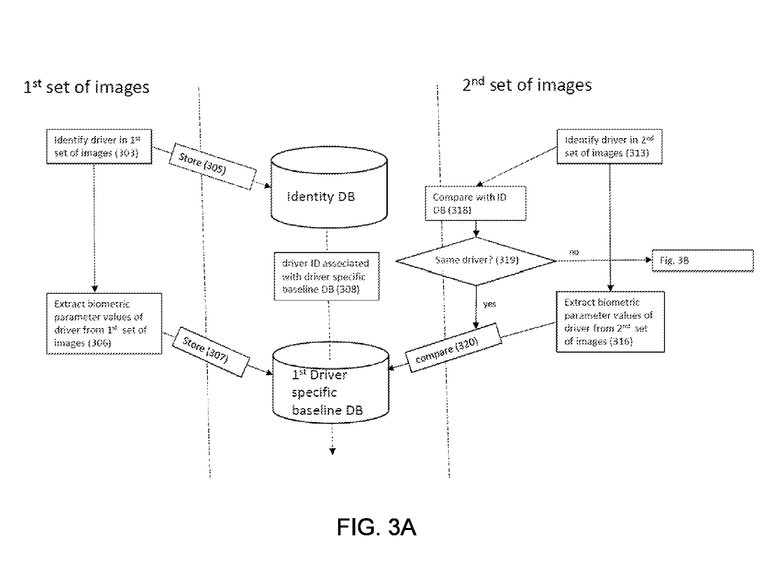

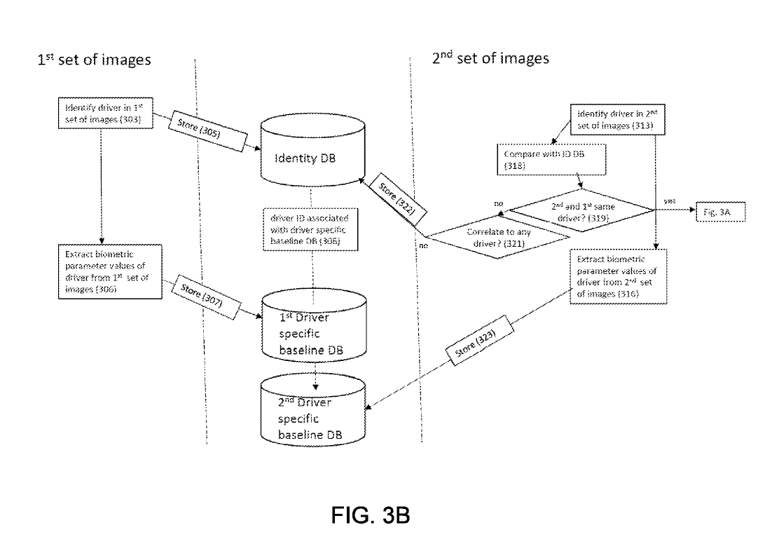

In one embodiment, which is schematically illustrated in FIGS. 3A and 3B, an initial step includes identifying a driver associated with a set of images. In one embodiment the driver is identified from at least one image from the set of images. The identity of the driver is then stored in a driver identity database (identity DB).

A subsequent driver is identified in association with a second set of images. The subsequent driver identity may then be searched against the identity DB. If the subsequent driver identity correlates with an identity in the identity DB then the subsequent driver biometric parameter values can be compared to values stored in a correlating subsequent driver baseline DB.

As exemplified in FIG. 3A, a driver (referred to as first driver) is identified in a first set of images (303), for example, by using face recognition algorithms on the first set of images. The first driver identity is stored in a driver identity DB (305) and biometric parameter values of the first driver are extracted from the first set of images (306). The biometric parameter values of the first driver are stored in a first driver specific baseline DB (307). The first driver identity is associated with the first driver specific baseline DB (308), for example by using a pointer or appropriate lookup table.

A driver (referred to as second driver) is then identified in a second set of images (313) and biometric parameter values of the second driver are extracted from the second set of images (316). The identity of the second driver is searched against the driver identity DB (318). If the first driver and second driver are the same driver (319), namely, the second driver identity correlates with the first driver identity stored in the driver identity DB, then the biometric parameter values from the second set of images are compared to biometric parameter values in the first driver specific baseline DB (320).

Referring now to FIG. 3B, if the first driver and second driver are not the same driver, namely, the second driver identity does not correlate with the first driver identity (319), and if there is no driver identity in the driver identity DB that correlates to the second driver identity (321), then the second driver's identity is stored in the driver identity DB (322) and the biometric parameter values extracted from the second set of images are stored in a second driver specific baseline DB (323). The second driver identity is associated with the second driver specific DB (308) as described above.

Comparing biometric parameter values extracted from a set of images with biometric parameter values stored in a baseline database may include comparing a value of a specific parameter to a value of a corresponding biometric parameter. For example, a number of eye blinks per time period of the driver, extracted from a set of images of the driver may be compared to a number of eye blinks per time period stored in the driver's baseline DB.

In some embodiments a biometric parameter value(s) includes a combination of a plurality of measurements (e.g., an average of several measurements or another function or combination of measurement results).

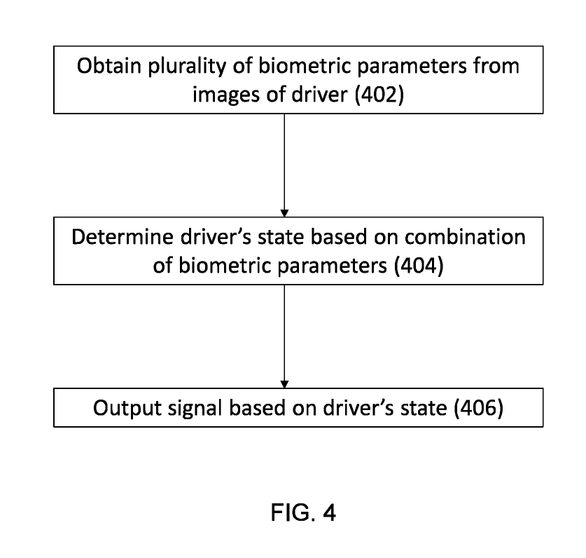

In one embodiment, which is schematically illustrated in FIG. 4, a method for determining a driver's state may include obtaining a plurality of biometric parameters of a driver from images of the driver in a vehicle (402) and determining the driver's state based on a combination of the biometric parameters (404). A signal is output based on the driver's state (406). The signal may be used to control a device such as an alarm or auxiliary device.

Thus, in some embodiments a biometric parameter value(s) includes a combination of values of different biometric parameters. For example, a frequency of eye blinks combined with heart rate and frequency of yawns may comprise a single biometric parameter value. The different values may be combined using appropriate functions. In one embodiment each value is assigned a weight (W) and the combined value is determined based on the following exemplary formula:

(eye blinks)×W₁+(heart rate)×W₂+(yawns)×W₃=biometric parameter value

In one embodiment each short term biometric value is compared with its corresponding long term biometric value and each comparison result is assigned a value. The value used to determine a driver's state includes a combination of comparison values. As described above, each comparison value may be assigned a weight and the final value by which a driver's state is determined may include a combination of weighted comparison values.

For example, a state of drowsiness may be determined based on a combination of comparisons of the short term and long term following parameters: eye blink rate (higher rate than baseline rate of eye blink), PERCLOS time (longer time than baseline PERCLOS time), movement of head (less movement than baseline head movement measurement), yawn (more and frequent yawns than baseline number of yawns), mouth (lip) movement (less movement than baseline measurements) and heart rate (slower heart rate than baseline heart rate). A combination of these comparison results typically indicates dangerous drowsiness.

In another example, a state of anxiety can be determined based on a combination of comparisons of the short term and long term following parameters: head movement (more head movement than baseline head movement) and eye movement (more rapid than baseline eye movement). A combination of these comparison results typically indicates high anxiety.

In yet another example a state of being under influence of drugs or alcohol can be determined based on a combination of comparison of short term and long term heart rate (higher than baseline heart rate) and pupil diameter (larger than baseline pupil diameter).

In another example a state of heavy mental load may be determined based on a combination of short term and long term gaze (fixed gaze compared to baseline gaze), pupil diameter (larger than baseline pupil diameter) and heart rate (higher than baseline heart rate).

Thus, a driver's state may be determined based on a combination of biometric parameter values.

In some embodiments, for each biometric value different statistical properties may be used. For example, the average value of eye blinks may be combined with the standard deviation value of yawns to determine short and/or long term values.

In some embodiments determining the driver's state based on a combination of biometric parameters may include comparing a combination of biometric parameter values extracted from images of a driver to a preset value. Deviation from the preset value (outside of a predetermined range from the preset value) may indicate unsafe driving causing a signal to be generated, whereas if the combination of extracted values is similar to the preset value (within a predetermined range from the preset value), this would be an indication of safe driving.

In another embodiment determining the driver's state based on a combination of biometric parameters may include comparing a combination of short term biometric parameter values extracted from images of a driver to a pre-set threshold. In some embodiments a combination of short term biometric values that is above or below the pre-set threshold indicates unsafe driving.

For example, a state of readiness to take control of the car may be determined by combining several, typically short term biometric values and comparing them to a pre-set threshold such as, direction of gaze and PERCLOS. In this example if the direction of the driver's head position and eye gaze is at the road for more than 2 seconds, with normal eyes and head pattern (i.e., not fixated), then the driver's readiness to take control of the car is determined to be high.

In one embodiment a method for controlling a device associated with a vehicle includes adjusting a threshold of the device based on a determined driver's state.

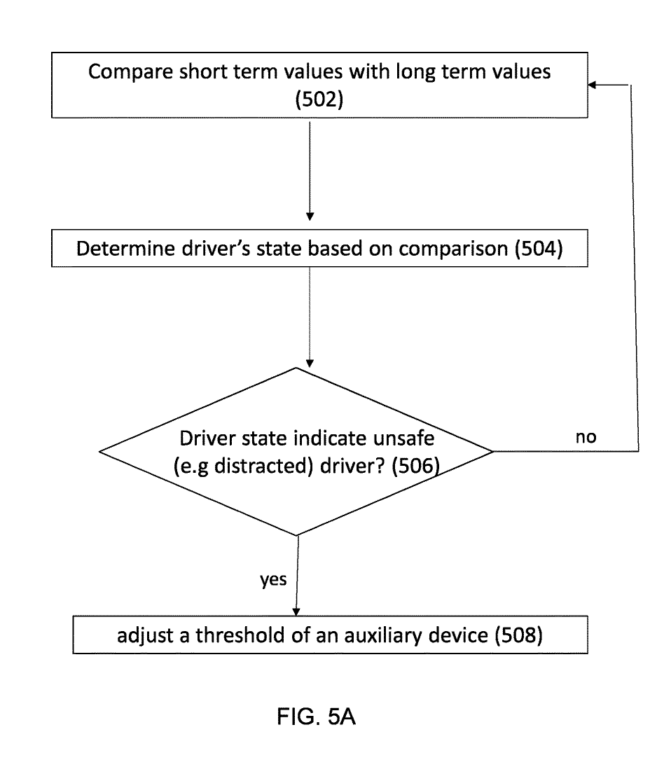

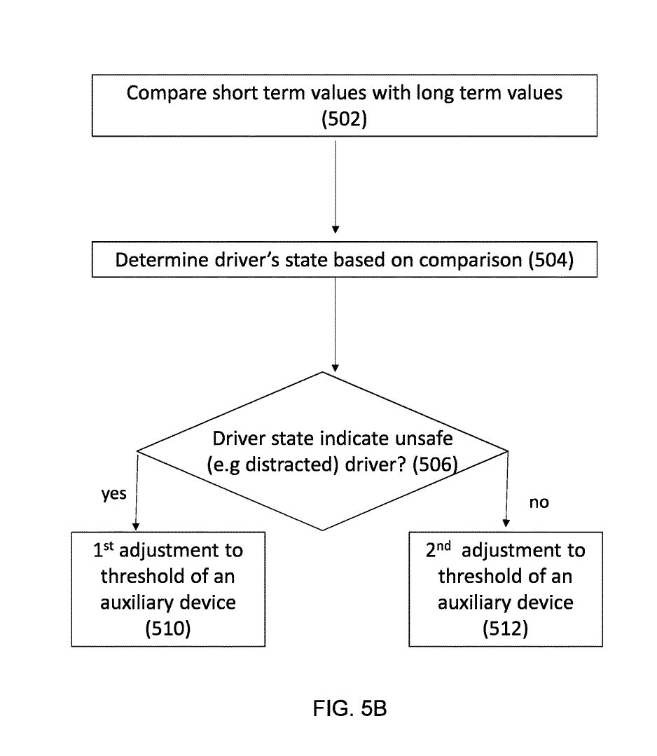

In some embodiments the method includes determining a driver's state from images of the driver and adjusting a threshold of an auxiliary device in the vehicle based on the driver's state. In examples schematically illustrated in FIGS. 5A and 5B, short term biometric parameter values of a driver are compared with long term biometric parameter values of the driver and a threshold of an auxiliary device in the vehicle is adjusted based on the comparison.

As exemplified in FIG. 5A, short term biometric parameter values of a driver are compared with long term biometric parameter values of the driver (502) and the driver's state is determined based on the comparison (504). If the driver's state indicates unsafe driving (506) a preset threshold of an auxiliary device such as an alarm or ADAS may be adjusted (e.g., lowered) (508). If the driver's state does not indicate unsafe driving (506) the threshold of the auxiliary device is not adjusted and the process proceeds to further compare short term and long term biometrics. Thus, based on a driver's state which indicates unsafe driving an alarm may be sounded earlier than it would have sounded if the driver's state did not indicate unsafe driving or an ADAS may be adjusted to be more sensitive if unsafe driving is detected.

In some embodiments different signals may be generated depending on the determined state of driver.

In the example depicted in FIG. 5B short term biometric parameter values of a driver are compared with long term biometric parameter values of the driver (502) and the driver's state is determined based on the comparison (504). If the driver's state indicates unsafe driving (506) then a first adjustment is made to the threshold of the auxiliary device (510) and if the driver's state does not indicate unsafe driving (506) then a second adjustment is made to the threshold of the auxiliary device (512).

For example, the first adjustment may be to raise a threshold and the second adjustment may be to lower the threshold. Thus, for example, a signal may be generated to raise the alarm threshold of a collision warning system if the driver's readiness state is determined to be high and a signal to lower the alarm threshold of a collision warning system may be generated if the driver's readiness state is determined to be low.

The value of biometric parameters of the driver may be extracted from images of the driver in the vehicle, for example, as described above.

In one embodiment adjustment of the device threshold may be proportional to the biometric parameter value being measured. For example, if unsafe driving is determined based on a comparison of short term value of frequency of eye blinks to a baseline value of frequency of eye blinks, then the threshold of an auxiliary device may be lowered in proportion to the difference between the short term value and the baseline value of frequency of eye blinks.

Embodiments of the invention provide high speed and low cost solutions to the problem of vehicle accidents, potentially facilitating widespread adoption of these life-saving solutions in vehicles.

What is claimed is:

1. A method for monitoring a driver's state, the method comprising:
obtaining a baseline biometric parameter value of a driver from a first set of images;
obtaining a current biometric parameter value of the driver from a second set of images;
comparing the current value with the baseline value; and
outputting a signal based on the comparison.

2. The method of claim 1 and further comprising:
identifying a first driver in at least one image from the first set of images;
identifying a second driver in at least one image from the second set of images;
correlating the second driver with the first driver; and
comparing the current value with the baseline value based on the correlation.

3. The method of claim 1 and further comprising changing the baseline value based on the current value.

4. The method of claim 3 and further comprising comparing the current value to the baseline and changing the baseline value based on the current value if the current value is within a predetermined range from the baseline value.

5. The method of claim 1 wherein the baseline value and the current value each comprise a combination of values.

6. The method of claim 1 wherein the baseline value and the current value each comprise a statistical property of a biometric parameter value.

7. The method of claim 6 wherein the baseline value and the current value each comprise a combination of values, each value and further comprising a different statistical property.

8. The method of claim 1 wherein biometric parameters comprise one or more of: eye pupil direction, pupil diameter, head rotation, blink frequency, mouth area size, mouth shape, percentage of eyelid closed, location of head, and pose of driver.

9. The method of claim 1 wherein the first set of images includes more images than the second set of images.

10. The method of claim 1 wherein the signal is to control an auxiliary device.

11. The method of claim 10 wherein the signal is to adjust a threshold of the auxiliary device.

12. The method of claim 10 wherein the auxiliary device comprises an alarm device or an ADAS.

13. The method of claim 1 and further comprising performing a time series analysis to extract statistical properties of the baseline biometric parameter value and of the current biometric parameter value, wherein comparing the current value with the baseline value comprises comparing the statistical properties of the baseline biometric parameter value and the statistical properties of the current biometric parameter value.

14. A system comprising:
a processing unit configured to
track at least part of a driver in a first set of images to extract biometric parameter values of the driver based on the tracking,
store the values in a biometric database associated with the driver, and
compare biometric parameter values of the driver extracted based on tracking of the part of the driver in a second set of images to the values stored in the biometric database.

15. The system of claim 14 and further comprising an image sensor in communication with the processing unit, the image sensor configured to obtain images of the at least part of the driver.

16. The system of claim 14 wherein the processing unit is configured to identify the driver from at least one image from the first set of images, and communicate with the biometric database based on the driver identification.

17. The method of claim 14 wherein the part of the driver comprises the driver's head.

18. The system of claim 14 wherein the processing unit is configured to control an auxiliary device based on the comparison of the biometric parameter values of the driver.

19. The system of claim 14 wherein the processing unit is part of an already existing vehicle processor.

20. The system of claim 14 and further comprising an IR illumination source.
